(19) United States
(12) Patent Application Publication
(10) Pub. No.: US 2011/0289923 A1
(43) Pub. Date: Dec. 1, 2011

(54) RECOVERY OF MERCURY CONTROL REAGENTS BY TRIBO-ELECTRIC SEPARATION

(75) Inventors: James D. Bittner, Acton, MA (US); Kyle P. Flynn, Framingham, MA (US); Frank J. Hrach, Mansfield, MA (US)

(73) Assignee: SEPARATION TECHNOLOGIES LLC, Needham, MA (US)

(21) Appl. No.: 13/116,575

(22) Filed: May 26, 2011

Related U.S. Application Data
(60) Provisional application No. 61/348,453, filed on May 26, 2010.

(51) Int. Cl. F01K 13/00; B03C 3/017; B01D 53/02

(52) U.S. Cl. 60/670; 95/134; 96/27

(57) ABSTRACT

A method and apparatus for recovering mercury control reagents from particulate materials is disclosed. The particulate materials include fly ash mixed with mercury control reagents collected from boiler flue gases. The particulate materials are provided to an electrostatic separation system, which is operated under predetermined conditions so as to produce a concentrated stream of the mercury control reagent and a diluted stream containing minimal mercury control reagent.

### CROSS REFERENCE TO RELATED APPLICATIONS

This application claims priority under 35 U.S.C. §119(e) to U.S. Provisional Application No. 61/348,453 entitled RECOVERY OF POWDERED ACTIVATED CARBON BY TRIBO-ELECTRIC SEPARATION filed on May 26, 2010, and which is herein incorporated by reference in its entirety.

### BACKGROUND

1. Field of Invention

The present invention relates generally to a method and apparatus for recovering mercury control reagents from streams of particulate material, and in particular, to coal burning plants and electrostatic separators for separating mercury control reagents from fly ash products resulting from coal burning systems.

2. Discussion of Related Art

Mercury is a naturally occurring element which can be harmful to human health, especially unborn babies and children. World-wide, tremendous quantities of coal are burned to generate electricity. Typically, coal is pulverized to a fine powder, pneumatically conveyed into an electric utility boiler and burned as a dispersed powder with the heat that is liberated being used to produce steam to power turbines and generate electricity. In a boiler, the carbonaceous constituents in coal burn to release heat. The non-carbonaceous materials are heated to high temperatures and typically melt and pass through and out of the boiler as fly ash. This fly ash is collected prior to the flue gases going up the stack and being dispersed in the atmosphere. Ash levels in coal sources vary considerably, but are typically in the range of about 8-12%. As a result, fly ash is produced at very high volumes throughout the industrialized world.

Mercury is a naturally occurring component in coal that is present at trace concentrations that typically range about 10 to 150 parts per billion. In an electric utility boiler, the mercury content of the coal is volatilized into the gas phase during the high temperature combustion processes. Mercury typically exists in the boiler as both a vapor and adsorbed on solid particles such as fly ash, with the split dependent on the specific process configuration and operating conditions utilized. The mercury present as vapor is emitted to the atmosphere. There have been significant efforts expended on the development and implementation of air pollution control technologies for capturing vapor-phase mercury emissions from combustion processes including wet scrubbers and the injection of mercury control reagents.

### SUMMARY OF INVENTION

Aspects and embodiments are directed to a method and apparatus for recovering mercury control reagents from streams of particulate material.

According to one embodiment, a method for recovering mercury control reagents from particulate materials comprises using an electrostatic separation system to produce a concentrated stream containing the recovered mercury control reagent suitable for re-use, and a diluted stream containing minimal mercury control reagent.

In one example, the particulate material is fly ash from coal-fired generation contaminated with powdered activated carbon, and the separation system produces a concentrated stream of powdered activated carbon with residual adsorptive capacity that can be re-used as a mercury emission control sorbent at the coal-fired electric utility boiler that generated the feed fly ash, and produces a diluted stream containing minimal powdered activated carbon that can be used as a cement substitute in the manufacture of ready mix concrete and concrete products.

In one example, the recovered mercury control reagent is activated carbon. In another example, the mercury control reagent is powdered activated carbon. In another example, the mercury control reagent is halogenated powdered activated carbon. In one example, the particulate material is any of fly ash from coal-fired electric generation boilers, ash from municipal solid water incinerators, or any other granulated material containing mercury control reagents.

In one example, the separation system is a belt-type, tribo-electrostatic separation device. In one example, the electrostatic separation system consists of multiple electrostatic separation devices staged with recycle streams to improve overall recovery efficiency of powdered activated carbon.

In one example, the particulate material is fly ash from coal-fired generation contaminated with powdered activated carbon, and the separation system is operated to process fly ash in such a way as to produce a concentrated stream containing powdered activated carbon so that the recovery efficiency of powdered activated carbon is greater than the recovery efficiency of other residual carbon contaminants in the fly ash.

In one example, the particulate material is fly ash from coal-fired generation contaminated with halogenated powdered activated carbon, and the separation system is operated to process fly ash in such a way as to produce a concentrated stream containing halogen so the recovery efficiency of halogen is greater than the recovery efficiency of carbon contaminants in the fly ash.

According to another embodiment, a method for recovery and re-use of powdered activated carbon (PAC) from coal combustion fly ash comprises injecting fresh PAC into a coal combustion boiler as a sorbent to control the air emissions of mercury, adsorption of gas phase mercury onto a surface of the PAC, separation of the PAC and coal combustion fly ash from the boiler flue gases in a common ash collection device, and mixing of the PAC and fly ash to form a feed stream in an ash collection device and storage silos. The method further comprises tribo-electrostatic separation of the feed stream to produce a concentrated stream containing a majority of the PAC and a dilute stream containing trace amounts of the PAC. The method further comprises recycle of the concentrated PAC stream to the coal combustion boiler to reduce the injection rate of fresh PAC.

In one example, the method includes using the concentrated PAC stream as a mercury sorbent at coal combustion boilers other than the boiler used to generate the feed stream. In one example, the method includes use of the dilute PAC stream as a cement replacement in the manufacture of ready-mix concrete and concrete products.

In one example, the tribo-electrostatic separation includes multiple tribo-electrostatic separators arranged in a multiple pass scheme with recycle streams comprising a first-pass separation of the feed stream to produce an intermediate concentrated PAC stream and an intermediate dilute PAC stream. In another example, the tribo-electrostatic separation includes a second-pass separation of the intermediate concentrated PAC stream to produce a concentrated PAC stream for recycle to the coal combustion boiler, and an intermediate feed recycle stream for recycle to the separation feed. In still another example, the tribo-electrostatic separation includes a second-pass separation of the intermediate dilute PAC stream to produce a dilute PAC stream for use as a cement replacement in the manufacture of ready mix concrete and concrete products, and an intermediate feed recycle stream for recycle to the separation feed.

According to another embodiment, tribo-electrostatic separators are arranged in triple-pass and greater configurations with recycle to the feed stream of the preceding pass.

According to another embodiment, a method for recovering mercury control reagents from particulate materials comprises collecting the particulate materials including mercury control reagents from a boiler, providing the particulate materials including the mercury control reagents to an electrostatic separation system, and operating the electrostatic separation system under predetermined conditions so as to produce a concentrated stream of the mercury control reagent and a diluted stream containing minimal mercury control reagent.

In one example, the mercury control reagent is powdered activated carbon. In another example, the mercury control reagent is halogenated powdered activated carbon.

In one example, the particulate material is fly ash collected from any of a coal-fired electric generation boiler, ash from a municipal solid water incinerators, and granulated material containing mercury control reagents.

In one example, the electrostatic separation system separation system includes at least one belt-type, tribo-electrostatic separation device.

In one example, the particulate material is fly ash collected from a coal-fired generation boiler and is contaminated with activated carbon, and the electrostatic separation system produces a concentrated stream of activated carbon with residual adsorptive capacity that can be re-used as a mercury emission control sorbent at the coal-fired electric utility boiler, and the electrostatic separation system produces a diluted stream containing minimal activated carbon that can be used as a cement substitute in the manufacture of ready mix concrete and concrete products.

In one example, the electrostatic separation system comprises operating multiple electrostatic separation devices staged with recycle streams to improve an overall recovery efficiency of the activated carbon.

In one example, the electrostatic separation system is operated to process the fly ash so that the recovery efficiency of powdered activated carbon is greater than a recovery efficiency of other residual carbon contaminants in the fly ash.

In one example, the electrostatic separation system is operated to process the fly ash so that the recovery efficiency of halogenated activated carbon is greater than a recovery efficiency of other residual carbon contaminants in the fly ash.

In one example, operating the electrostatic separation system further comprises first, second and third separators, the first separator separating the particulate materials including the mercury control reagent to produce an intermediate concentrated stream of the mercury control reagent and an intermediate dilute stream of the mercury control reagent. The second separator separating of the intermediate concentrated stream of the mercury control reagent to produce the concentrated stream of the mercury control reagent and a first intermediate feed recycle stream for recycle to the first separating. The third separator separating of the intermediate dilute stream of the mercury control reagent to produce the diluted stream and a second intermediate feed recycle stream for recycle to the first separating.

In another embodiment, a method for recovering and re-using a mercury control reagent from coal combustion fly ash comprises injection of a fresh mercury control reagent into a coal combustion boiler as a sorbent, and adsorption of gas phase mercury onto a surface of the mercury control reagent. The method further comprises separation of the mercury control reagent and coal combustion fly ash from the coal combustion boiler flue gases, collection of the mercury control reagent and the coal combustion fly ash, and mixing of the mercury control reagent and the coal combustion fly ash to form a feed stream. The method further comprises tribo-electrostatic separation of the feed stream to produce a concentrated stream of the mercury control reagent and a diluted stream containing trace amounts of the mercury control reagent, recycling of the concentrated mercury control reagent to the coal combustion boiler to reduce the amount of fresh mercury control reagent injected into the coal combustion boiler as a sorbent, and adsorption of gas phase mercury onto a surface of the concentrated mercury control reagent.

In one example, the diluted stream as an additive in the manufacture of ready-mix concrete and concrete products. In one example, the recovered mercury control reagent is powdered activated carbon. In another example, the recovered mercury control reagent is halogenated activated carbon.

In one example, the tribo-electrostatic separation comprises first, second and third separators. The first separator separating the feed stream to produce an intermediate concentrated stream of the mercury control reagent and an intermediate dilute stream of the mercury control reagent. The second separator separating the intermediate concentrated stream of the mercury control reagent to produce the concentrated stream of the mercury control reagent and a first intermediate feed recycle stream for recycle to the first separating. The third separator separating the intermediate dilute stream of the mercury control reagent to produce the diluted stream and a second intermediate feed recycle stream for recycle to the first separating.

In one embodiment, a separator apparatus for recovering mercury control reagents from particulate materials comprises a triboelectric separator that receives the particulate materials and that is configured to operate under predetermined conditions so as to produce a concentrated stream of the mercury control reagents and a diluted stream containing minimal mercury control reagent.

In one example, the separator apparatus comprises a first separator, a second separator, and a third separator. The first separator receives the particulate materials and is configured to operate under predetermined conditions so as to separate the particulate materials to produce an intermediate concentrated stream of the mercury control reagent and an intermediate dilute stream of the mercury control reagent. The second separator receives the intermediate concentrated stream of the mercury control reagent and is configured to operate under predetermined conditions so as to separate the intermediate concentrated stream of the mercury control reagent to produce the concentrated stream of the mercury control reagent and a first intermediate feed recycle stream for recycle to the first separator. The third separator receives the intermediate concentrated stream of the mercury control reagent and is configured to operate under predetermined conditions so as to separate the intermediate concentrated stream of the mercury control reagent to produce the diluted stream and a second intermediate feed recycle stream for recycle to the first separator.

In one example, the first separator is operated with a belt speed of approximately 60 fps, an electrode gap of approximately 0.390 inches, having a feed point located approximately one quarter of an electrode length, with a voltage difference of approximately 8 kV applied between electrodes, and with a top electrode having a positive polarity.

In one example, the second separator is operated with a belt speed of approximately 40 fps, an electrode gap of approximately 0.450 inches, having a feed point located approximately three quarters of an electrode length, with approximately an 8 kV applied voltage difference, and with a top electrode having a negative polarity.

In one example, the third separator is operated with a belt speed of approximately 60 fps, an electrode of approximately 0.390 inches, having a feed point located approximately in a center of an electrode length, with a voltage difference of approximately 8 kV applied between electrodes, and a top electrode having a positive polarity.

In one example, a utility power plant system includes any of the embodiments of a the separator apparatus and further comprises a boiler for burning coal to produce heat used to generate electricity, the boiler producing non-combustible materials including mercury that exit the boiler in the form of flue gases. The utility power plant further comprises a mercury reagent injection system for injecting a mercury control reagent into the coal combustion boiler as a sorbent for the mercury in the flue gases. The utility power plant also comprises an ash disengagement system, coupled to the boiler, which receives the flue gases exiting the boiler, that separates the mercury control reagent having mercury adsorbed onto a surface of the mercury control reagent and coal combustion fly ash from the flue gases. The utility power plant also comprises a collection device that collects the mercury control reagent and the fly ash contained within the flue gases.

Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments

### BRIEF DESCRIPTION OF THE DRAWINGS

Various aspects of at least one embodiment are discussed below with reference to the accompanying figures, which are not intended to be drawn to scale. Where technical features in the figures, detailed description or any claim are followed by references signs, the reference signs have been included for the sole purpose of increasing the intelligibility of the figures, detailed description, and claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. The figures are provided for the purposes of illustration and explanation and are not intended as a definition of the limits of the invention.

In the figures:

FIG. 1 illustrates one embodiment of a mercury control reagent recovery and recycle apparatus; and

FIG. 2 illustrates a multiple-stage separation apparatus to achieve sufficiently high mercury control reagent concentration from contaminated fly ash resulting from the combustion of coal to provide a concentrated mercury control reagent stream and a diluted fly ash stream.

### DETAILED DESCRIPTION

As discussed above, there have been significant efforts expended on the development and implementation of air pollution control technologies for capturing vapor-phase mercury emissions from combustion processes. However such technologies can be expensive and inefficient. Aspects and embodiments are directed to a method and apparatus for recovering mercury control reagents from vapor-phase mercury and from streams of particulate material. In one aspect, a mercury containing reagent can be recovered from coal combustion fly ash which has been contaminated by the mercury control reagent as a result of being used to reduce the air emission of mercury resulting from the coal combustion. The recovered mercury control reagent is processed by an electrostatic separator to a sufficient concentration so that it is suitable for re-use as mercury sorbent in mercury air emission control for a combustion system.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

It is to be understood that Mercury control reagents are manufactured substances that are injected into the boiler system to reduce the emission of mercury from the boiler system to the atmosphere. Examples of mercury control reagents include, but are not limited to, powdered activated carbon (PAC), halogenated powdered activated carbon (HPAC), and halogens. However, it is to be understood that unburned coal char, which is a normal by-product of coal combustion, is not a mercury control reagent.

An exemplary system for separating flyash from carbon materials resulting from a coal fired boiler of an electric generating plant is disclosed in U.S. Pat. No. 6,074,458, which is herein incorporated by reference. One exemplary system includes a coal fired boiler, a mechanism for flyash transport, storage, and processing of the flyash with a triboelectric electrostatic counter current belt separator, such as is described in U.S. Pat. Nos. 4,839,032 and 4,874,507 (hereinafter the '032 and '507 patents), which are herein incorporated by reference. As is typical in industry practice, the coal is pulverized, for example, by roller and conveyed by a conveyor to the boiler, where it burns as a dispersed powder. The burned coal heats a tube containing water thereby heating the water to form steam which expands through a turbine driving a generator to generate electricity. The steam is also condensed back into liquid water and is pumped by pump back into the boiler where it is continuously heated and condensed within a closed loop system. Any unburned material of the burned coal passes by the heat transfer tubes in the form of flue gases to an ash disengagement system such as, for example, an electrostatic precipitator hopper, where the ash solids are removed and where the flue gas passes through and up a stack where it is dispersed into the atmosphere.

Typically the ash solids are conveyed from the precipitator hopper to a remote storage vessel silo. The silo is connected to the triboelectric, counter current, belt type separator. As the flyash leaves the silo, it is passed through a screen, for example within a hopper, to remove any tramp material which might otherwise interfere with separator performance. After passing through the screen, the flyash is then introduced into the separator where the carbon is triboelectrically charged and is electrostatically separated from the flyash. A means for conveying and distributing the flyash in a uniform manner is also used.

Injection of mercury control reagents have been shown to be effective in controlling the air emissions of mercury from coal-fired utility boilers, municipal waste incinerators, and other combustion processes. Mercury control reagents are typically injected into the post-combustion gas stream upstream of the particulate collection device. The injection point is chosen to allow sufficient residence time in a relatively low temperature region of the combustion process to allow efficient adsorption and reaction of the vapor-phase mercury onto the mercury control reagent particle, prior to collection in a particulate control device and mixing with the majority fuel ash particles. For the case of electric utility boilers burning sub-bituminous coal from the western US, high mercury removal rates have been demonstrated when using halogenated activated carbons injected at 5 lb HPAC per million actual cubic foot of flue gas just upstream of a fabric filter particulate collection device. Somewhat lower mercury removal rates are observed for systems with electrostatic precipitator particulate collection devices. The use of halogenated (for example, brominated) PAC has been demonstrated to significantly enhance mercury removal efficiency. However, one adverse consequence of using HPAC for mercury control in coal-fired boilers is that the collected fly ash becomes contaminated with the injected HPAC.

The injection of halogens, such as bromine or chlorine, has been shown to greatly increase the mercury removal efficiency from coal-fired boilers. The injection of halogens is thought to oxidize a portion of the flue gas mercury from the elemental (Hg⁰) state to the oxidized (Hg⁺²) state. The adsorption of oxidized mercury on PAC or any other adsorbent carbon surface is greatly enhanced when compared to the adsorption of elemental mercury.

Historically, one of the major outlets for coal fly ash has been as an additive that replaces a portion of the cement used in the manufacture of ready mix concrete and concrete products. Fly ash containing concrete is stronger, more workable, and more resistant to chemical attack. The valuable use of fly ash in concrete can turn a high volume waste into a high volume recycled building material.

The use of fly ash in concrete requires that the fly ash have specific physical and chemical properties. One of the major contaminants that limit the widespread usage of fly ash in concrete is the presence of small amounts of carbon. Among other detrimental effects, carbon can adsorb the air-entraining and other admixture chemicals that are added during the concrete batching process. The adsorbed admixture is ineffective in controlling the concrete properties requiring the concrete producer to increase the dosage to offset the adsorption. Furthermore, variation in carbon content from batch to batch can lead to variation in concrete properties, and ultimately in unusable material. The foam index (FI) test is an analytical laboratory method that measures the propensity of a fly ash sample to adsorb a model air entraining admixture used in concrete manufacture. Fly ash with a foam index (FI) value less than 0.5 is generally considered to be suitable for use in concrete. When fly ash is contaminated with PAC, the carbon contamination problem is significantly worse since PAC carbons are specifically designed to have extremely high adsorption capacity. The net result is that PAC contaminated fly ash is not usable as a cement replacement in concrete. PAC manufacturers have started to address this problem by introducing so called “concrete-friendly” PAC where the PAC surface is treated to limit the influence of PAC on the concrete properties. The effectiveness of “concrete-friendly” PAC in mitigating the deleterious effects in concrete has not been consistently demonstrated.

The rate of vapor-phase mercury collection using a mercury control reagent is controlled by external mercury transport and mixing of the bulk gas with the reagent particle. As a result, the collected reagent material still has significant residual mercury adsorptive capacity after a single use. Since the injected reagent is typically collected and diluted with much higher volume fly ash stream, the re-use of the collected reagent is impractical. Therefore, the operator of the boiler incurs a significant new operating cost to purchase fresh reagent for continuous injection. Since the injected reagent contaminates the much larger fly ash stream, making it unusable as a cement replacement, one unintended side effect of the mercury control legislation and mitigation using mercury control reagents is reduction in fly ash recycling and the increase in the use of landfills to dispose of collected fly ash from coal-fired power plants.

One commercially successful device for processing and separating the constituent particles within fly ash is the tribo-electrostatic belt separator as disclosed in the '032 and '507 patents. In this device, the separation occurs by introduction of particles into a high strength electric field produced by two planar electrodes separated by a narrow gap. The particles are conveyed through the electric field by the action of a high speed, continuous loop meshed belt as described in U.S. Pat. Nos. 5,819,946 and 5,904,253, which are herein incorporated by reference. The particles are charged by tribo-electric contact based on the difference in work function of each constituent particle. After charging, the particles migrate toward the electrode of opposite sign and are collected by the movement of the loop mesh belt and deposited into a collection hopper at either end of the electrode length. The motion of the belt produces a high shear zone in the narrow gap which results in frequent particle collisions, particle charging and re-charging, and a multiple-stage counter-current efficient separation. In this device, the recovery of one constituent from another can be easily controlled by changing operating parameters. The major operating parameters that influence the separation efficiency of a particulate material are the speed of the belt, the gap between the electrodes, the position of the feed point along the electrode length, the applied electrode voltage, and the polarity of the applied electric field. Normal operating ranges for the operating parameters are: belt speed of 10 to 70 feet per second; gap between electrodes of 0.250 to 0.600 inches, feed port locations of one quarter, center, and three quarters of electrode length; applied voltage difference between 6 kV to 12 kV; and a polarity of either top electrode positive or top electrode negative.

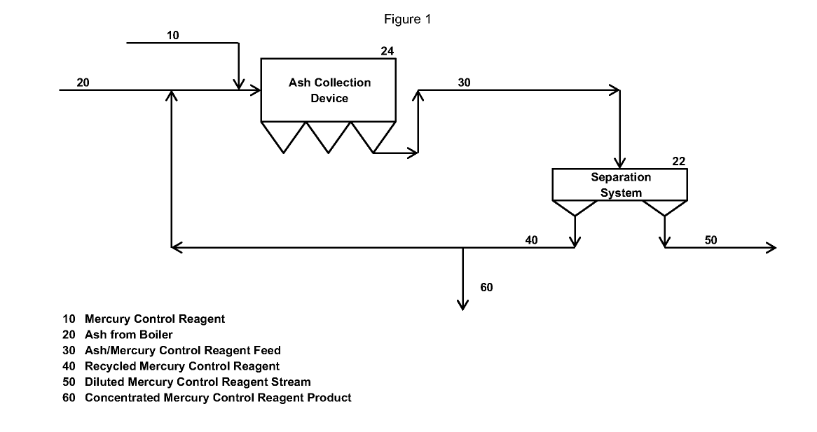

Referring to FIG. 1, According to embodiments and aspects of a method and apparatus, an electrostatic belt-type separator 22 that has been effective in removing residual coal char particles from the primarily siliceous mineral fly ash, can be operated so that it efficiently separates fly ash contaminated with a mercury control reagent (feed stream 30) into a concentrated stream 40 containing a majority of the mercury control reagent, and a dilute stream 50 containing only trace amounts of mercury control reagent. With such an arrangement, the concentrated stream 40 can be provided that has sufficient mercury control reagent purity so that it is possible to recycle it back to the particulate collection device 24 of the coal combustion boiler for re-use as a mercury reduction sorbent. The recycled mercury control reagent can be mixed with fly ash from the boiler 20 and with fresh mercury control reagent 10 so as to reduce an amount of fresh mercury control reagent needed. Thus, with this arrangement, the mercury control reagent can be recycled and the amount of mercury control reagent that is used to achieve a given level of mercury reduction in the coal-fired combustion boiler can be reduced.

For the concentrated stream of recycled mercury control reagent 40 to be useful as a mercury control reagent, the concentration of reagent must be sufficiently high and the recycled fly ash concentration must be sufficiently low, so that the concentrated stream mass flow rate does not exceed the capacity of the coal-fired boiler particulate collection device. Typical electrostatic precipitator particulate collection devices are oversized by at least 10%. For a typical coal-fired boiler system combusting sub-bituminous coal where, for example, HPAC is injected at the rate of 5 lb HPAC per million actual cubic feet of combustion gas, the resultant fly ash will contain approximately 2 wt % HPAC. If 90% of this HPAC were recovered and recycled to the HPAC injection point, it would be necessary for the concentration of HPAC in the concentrated stream to exceed 18% to ensure that the particle collection device capacity is not exceeded.

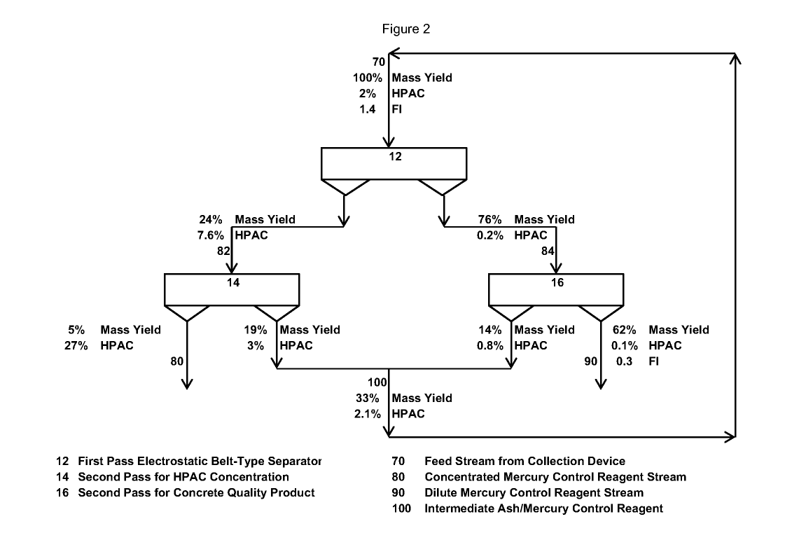

Referring to FIG. 2, several electrostatic belt-type separators 12, 14 and 16 can be configured in a multiple-stage scheme to achieve sufficiently high HPAC concentration in a concentrated stream 80. In one example, the first separator 12 was fed a flyash HPAC mixture 70 from an ash collection device, and was operated with a belt speed of 60 fps, an electrode gap set at 0.390 inches, using a feed point located one quarter of the electrode length, with a voltage difference of 8 kV applied between the electrodes, and the top electrode having a positive polarity. The second separator 14 received an intermediary stream 82 from the first separator 12, and was operated with a belt speed of 40 fps, an electrode gap set at 0.450 inches, using a feed point located three quarters of the electrode length, with 8 kV applied voltage difference, and the top electrode with a negative polarity to provide the concentrated stream 80 and an intermediate ash/mercury control reagent stream 100, which was fed back to the first separator 12. The third separator 16 also received an intermediary stream 84 from the first separator 12, and was operated with a belt speed of 60 fps, an electrode gap set at 0.390 inches, using a feed point located in the center of the electrode length, with a voltage difference of 8 kV applied to the electrodes, and the top electrode with positive polarity to provide the diluted stream 90 and an intermediate ash/mercury control reagent stream 100, which was fed back to the first separator 12.

The second separator 14 provided a concentrated HPAC stream 80 that was measured to contain 27% HPAC and sufficient residual mercury sorption capacity so that it is effective for re-use as a mercury control reagent. The maximum mercury concentration on the recovered HPAC was estimated by measuring the mercury content of the concentrated stream divided by the estimated HPAC concentration of the concentrated stream. This calculation results in a maximum mercury concentration on the HPAC contained in the concentrated stream of approximately 40 microgram Hg per gram of HPAC. When compared to the measured virgin PAC adsorption capacity of approximately 1600 microgram Hg per gram of HPAC, this calculation shows that less than 2.5% of the mercury sorption capacity of the HPAC is utilized after a single use.

Furthermore, the fly ash separation system as illustrated in FIG. 2 was operated in such a way as to produce a dilute stream 90 from the third separator 16 with minimal residual HPAC concentration, which was sufficiently low so that the dilute stream can be utilized as a cement replacement in the manufacturing of ready mixed concrete and concrete products. The suitability of the dilute stream for use as a cement replacement can be measured by the foam index (FI) property of the fly ash. If the foam index level of the dilute stream is less than about 0.5, the dilute stream is suitable for use as a cement replacement. As illustrated in FIG. 2, the several electrostatic belt-type separators 12, 14, and 16 can be configured in a multiple-stage scheme to also produce a dilute stream 90 with FI measurement sufficiently low so that the dilute stream can be utilized as cement replacement.

One advantageous feature of the embodiments disclosed herein is that when applied to the recovery of HPAC from contaminated coal combustion fly ash, the recovery efficiency of the HPAC in the concentrated stream can exceed the recovery efficiency of other non-HPAC carbon constituents in the concentrated stream. In contrast, if this were not the case for the embodiments disclosed herein, and the recovery efficiency of the HPAC were less than or equal to the recovery efficiency of non-HPAC carbon constituents, then the non-HPAC carbon concentration in the recycle stream would gradually increase over time, increasing the non-HPAC carbon concentration in the separation feed stream, and eventually exceeding the capability of the separation system to produce a low carbon dilute stream suitable for use as a cement replacement. For such a system, the system could only then continue operation if a portion of the recycled concentrated stream is purged as waste.

Mercury control reagent recovery efficiency can be estimated for any separation process by sampling the feed, concentrated, and dilute streams and analyzing each sample for reagent concentration. The reagent recovery efficiency can be calculated as a percentage of the feed material recovered in the concentrated stream. For the case of coal-combustion fly ash contaminated with bromine-treated HPAC, a convenient method to measure the HPAC recovery efficiency is to analyze the three streams for bromine content, and use bromine as a tracer for HPAC through the separation process. The recovery of total carbon can be measured in a similar manner using loss on ignition (LOI) analytical test. The recovery on non-PAC carbon can be estimated by difference. Referring to Table 1 below, results from a single-pass separation of bromine-treated PAC contaminated fly ash using an embodiment of an electro-static belt-type separator are presented. Table 1 illustrates that the recovery of bromine in the concentrated stream was very high (91%) and that the recovery of total carbon in the concentrated stream was less (83%). Accordingly, embodiments of the fly ash separation system can be operated in such a way that results in a recovery of bromine (and by implication PAC carbon) that exceeds the recovery of non-PAC carbon constitutes in the fly ash. Thus, one advantage is that the embodiments allow operation of the system with PAC recycle that minimizes any need to purge the recycled concentrated stream.

TABLE 1
Separation results for PAC contaminated fly ash from the
combustion of Western US sub-bituminous coal using
tribo-electrostatic belt-type separator

| | |
|---|---|
| Bromine recovery | 91% |
| PAC recovery¹ | 91% |
| Non-PAC carbon recovery² | 60% |
| Total carbon recovery³ | 83% |

¹PAC recovery calculated by bromine testing
²Non-PAC carbon recovery calculated by difference
³Total carbon recovery calculated using loss on ignition (LOI) testing

An overall advantage and result of the embodiments and aspects disclosed herein is that a PAC contaminated fly ash stream can be processed so that the majority of the stream is recycled either as mercury sorbent or re-used a cement replacement, minimizing the need to dispose of the fly ash stream in a landfill.

Having thus described several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method for recovering mercury control reagents from particulate materials comprising:
collecting the particulate materials including the mercury control reagents from a boiler;
providing the particulate materials including the mercury control reagents to an electrostatic separation system; and
operating the electrostatic separation system under predetermined conditions so as to produce a concentrated stream of the mercury control reagent and a diluted stream containing minimal mercury control reagent.

2. The method as recited in claim 1, wherein the mercury control reagent is powdered activated carbon.

3. The method as recited in claim 1, wherein the mercury control reagent is halogenated powdered activated carbon.

4. The method as recited in claim 1, wherein the mercury control reagent is powdered activated carbon treated to be concrete friendly.

5. The method as recited in claim 1, wherein the particulate material is fly ash collected from any of a coal-fired electric generation boiler, ash from a municipal solid waste incinerators, and granulated material containing mercury control reagents.

6. The method as recited in claim 1, wherein the operating the electrostatic separation system separation system includes operating at least one belt-type, tribo-electrostatic separation device.

7. The method as recited in claim 1, wherein the particulate material is fly ash collected from a coal-fired generation boiler and is contaminated with mercury control reagents, and the operating the electrostatic separation system produces a concentrated stream of mercury control reagents with residual adsorptive capacity that can be re-used as a mercury emission control sorbent at the coal-fired electric utility boiler, and operating the electrostatic separation system produces a diluted stream containing minimal mercury control reagent that can be used as a cement substitute in the manufacture of ready mix concrete and concrete products.

8. The method as recited in claim 7, wherein the recovered mercury control reagent is powdered activated carbon.

9. The method as recited in claim 7, wherein the recovered mercury control reagent is halogenated activated carbon.

10. The method as recited in claim 7, wherein the mercury control reagent is powdered activated carbon treated to be concrete friendly.

11. The method as recited in claim 7, wherein the recovered mercury control reagent is activated carbon and operating the electrostatic separation system comprises operating multiple electrostatic separation devices staged with recycle streams to improve an overall recovery efficiency of the activated carbon.

12. The method as recited in claim 11, wherein, the electrostatic separation system is operated to process the fly ash so that a recovery efficiency of activated carbon is greater than the recovery efficiency of other residual carbon contaminants in the fly ash.

13. The method as recited in claim 11, wherein the recovered mercury control reagent is halogenated activated carbon the electrostatic separation system is operated to process the fly ash so that a recovery efficiency of halogenated activated carbon is greater than the recovery efficiency of other residual carbon contaminants in the fly ash.

14. The method as recited in claim 1, wherein the operating the electrostatic separation system comprises:
first separating the particulate materials including the mercury control reagent to produce an intermediate concentrated stream of the mercury control reagent and an intermediate dilute stream of the mercury control reagent;
second separating of the intermediate concentrated stream of the mercury control reagent to produce the concentrated stream of the mercury control reagent and a first intermediate feed recycle stream for recycle to the first separating; and
third separating of the intermediate dilute stream of the mercury control reagent to produce the diluted stream and a second intermediate feed recycle stream for recycle to the first separating.

15. A method for recovery and re-use of mercury control reagent from coal combustion fly ash, comprising the steps of:
injection of a fresh mercury control reagent into a coal combustion boiler as a sorbent;
adsorption of gas phase mercury onto a surface of the mercury control reagent;
separation of the mercury control reagent and coal combustion fly ash from the coal combustion boiler flue gases;
collection of the mercury control reagent and the coal combustion fly ash;
mixing of the mercury control reagent and the coal combustion fly ash to form a feed stream;
tribo-electrostatic separation of the feed stream to produce a concentrated stream of the mercury control reagent and a diluted stream containing trace amounts of the mercury control reagent;
recycling of the concentrated mercury control reagent to the coal combustion boiler to reduce the amount of fresh mercury control reagent injected into the coal combustion boiler as a sorbent; and
adsorption of gas phase mercury onto a surface of the concentrated mercury control reagent.

16. The method as recited in claim 15, further comprising using the diluted stream as an additive in the manufacture of ready-mix concrete and concrete products.

17. The method as recited in claim 15, wherein the recovered mercury control reagent is powdered activated carbon.

18. The method as recited in claim 15, wherein the recovered mercury control reagent is halogenated activated carbon.

19. The method as recited in claim 15, wherein the mercury control reagent is powdered activated carbon treated to be concrete friendly.

20. The method as recited in claim 15, where the tribo-electrostatic separation comprises:
first separating the feed stream to produce an intermediate concentrated stream of the mercury control reagent and an intermediate dilute stream of the mercury control reagent;
second separating of the intermediate concentrated stream of the mercury control reagent to produce the concentrated stream of the mercury control reagent and a first intermediate feed recycle stream for recycle to the first separating; and
third separating of the intermediate dilute stream of the mercury control reagent to produce the diluted stream and a second intermediate feed recycle stream for recycle to the first separating.

21. A separator apparatus for recovering mercury control reagents from particulate materials comprising a triboelectric separator that receives the particulate materials and that is configured to operate under predetermined conditions so as to produce a concentrated stream of the mercury control reagents and a diluted stream containing minimal mercury control reagent.

22. The separator apparatus as claimed in claim 21, further comprising:
a first separator that receives the particulate materials and that is configured to operate under predetermined conditions so as to separate the particulate materials to produce an intermediate concentrated stream of the mercury control reagent and an intermediate dilute stream of the mercury control reagent;
a second separator that receives the intermediate concentrated stream of the mercury control reagent and that is configured to operate under predetermined conditions so as to separate the intermediate concentrated stream of the mercury control reagent to produce the concentrated stream of the mercury control reagent and a first intermediate feed recycle stream for recycle to the first separator; and
a third separator that receives the intermediate concentrated stream of the mercury control reagent and that is configured to operate under predetermined conditions so as to separate the intermediate concentrated stream of the mercury control reagent to produce the diluted stream and a second intermediate feed recycle stream for recycle to the first separator.

23. The separator apparatus as claimed in claim 21, wherein the first separator is operated with a belt speed between 40 and 60 feet per second, an electrode gap between 0.350 and 0.450 inches, having a feed point located approximately one quarter of an electrode length away from a reduced mercury control reagent stream receiving hopper, with a voltage difference of approximately 8 kV applied between electrodes, and with a top electrode having a positive polarity.

24. The separator apparatus as claimed in claim 21, wherein the second separator is operated with a belt speed between 30 and 40 feet per second, an electrode gap between 0.350 and 0.450 inches, having a feed point located approximately three quarters of an electrode length away from a reduced mercury control reagent stream receiving hopper, with approximately an 8 kV applied voltage difference, and with a top electrode having a negative polarity.

25. The separator apparatus as claimed in claim 21, wherein the third separator is operated with a belt speed between 50 and 60 feet per second, an electrode gap between 0.350 and 0.450 inches, having a feed point located approximately one half an electrode length away from a reduced mercury control reagent stream receiving hopper, with a voltage difference of approximately 8 kV applied between electrodes, and a top electrode having a positive polarity.

26. A utility power plant system comprising the separator apparatus of claim 21, and further comprising:
a boiler for burning coal to produce heat used to generate electricity, the boiler producing non-combustible materials including mercury that exit the boiler in the form of flue gases;
a mercury reagent injection system for injecting a mercury control reagent into the coal combustion boiler as a sorbent for the mercury in the flue gases;
an ash disengagement system, coupled to the boiler, that receives the flue gases exiting the boiler, that separates the mercury control reagent having mercury adsorbed onto a surface of the mercury control reagent and coal combustion fly ash from the flue gases; and
a collection device that collects the mercury control reagent and the fly ash contained within the flue gases.
